(19) United States
(12) Patent Application Publication
(10) Pub. No.: US 2026/0309685 A1
(43) Pub. Date: Oct. 8, 2026

(54) WAVEFORM ANALYSIS METHOD, WAVEFORM ANALYSIS APPARATUS, AND ANALYSIS APPARATUS

(71) Applicant: SHIMADZU CORPORATION, Kyoto-shi (JP)

(72) Inventors: Junta KASHIMA, Kyoto-shi (JP); Shinji KANAZAWA, Kyoto-shi (JP)

(21) Appl. No.: 19/484,624

(22) PCT Filed: Jan. 29, 2024
(86) PCT No.: PCT/JP2024/002636

§ 371 Date: Nov. 14, 2025

(30) Foreign Application Priority Data
May 15, 2023 (JP) 2023-080100

(51) Int. Cl. G01N 30/86

(52) U.S. Cl. CPC G01N 30/8637; G01N 30/8644

(57) ABSTRACT

A signal waveform may be analyzed by creating a trained model by machine learning using a plurality of reference waveforms in which a position of a peak portion is known; decomposing a target signal waveform into a plurality of processing target waveforms, each having a predetermined data size; dividing each of the plurality of processing target waveforms into a plurality of partial waveforms, using the trained model to estimate whether each of the plurality of partial waveforms corresponds to each of a plurality of different types of regions including a peak region and a non-peak region, and obtaining individual region estimation information reflecting a probability of the correspondence; integrating the individual region estimation information to obtain region estimation information spanning the target signal waveform; and using the region estimation information to determine which of the plurality of regions each part in the target signal waveform is.

### TECHNICAL FIELD

The present invention relates to a method and an apparatus for analyzing a signal waveform acquired by an analysis apparatus, and an analysis apparatus provided with such a waveform analysis apparatus.

### Background Art

A chromatogram acquired by an analysis apparatus such as a gas chromatograph (GC) or a liquid chromatograph (LC) shows peaks originating from components contained in a sample. In a data processing apparatus included in such an analysis apparatus, peaks are generally detected by performing waveform processing on the chromatogram obtained by the analysis, and the peak of a target compound is identified by performing an identification process on a plurality of detected peaks. Further, in such a data processing apparatus, the concentration or content of the compound corresponding to the identified peak is calculated from the area or height of the peak.

Various methods have been put into practical use for detecting peaks, but in recent years, a method using machine learning has been proposed and put into practical use as a new peak detection method (see Patent Literature 1 and Non-Patent Literature 1).

In the waveform analysis method described in Patent Literature 1, a set including a plurality of partial waveforms, created by finely dividing a reference waveform with a known peak portion position along the time axis, is prepared for each reference waveform. A trained model for identifying a partial waveform corresponding to a peak portion included in an input waveform is created by machine learning using the partial waveforms for a large number of sets of reference waveforms. A model capable of semantic segmentation is used as the learning model. The processing target waveform is also divided into a plurality of partial waveforms in the same manner as the reference waveform, and it is determined whether each of the plurality of partial waveforms is a peak portion using the trained model. Then, based on the determination result, a peak region and other regions in the processing target waveform are determined. In this waveform analysis method, by performing machine learning using partial waveforms corresponding to a peak start point and a peak end point in addition to the peak portion, it is also possible to find the partial waveforms corresponding to the peak start point and the peak end point among the plurality of partial waveforms in the processing target waveform. Furthermore, by further dividing the peak portion into a single peak portion and an overlapping peak portion where a plurality of peaks overlap, it is also possible to determine a single peak region and an overlapping peak region within the processing target waveform.

### CITATION LIST

### Patent Literature

Patent Literature 1: International Publication No. 2021/064924

### Non-Patent Literature

Non-Patent Literature 1: “Peakintelligence for GCMS, Waveform Processing Software for LabSolutions Insight,” [online], [searched Apr. 18, 2023], Shimadzu Corporation, Internet <URL: https://www.an.shimadzu.co.jp/products/gas-chromatograph-mass-spectrometry/gc-ms-software/peakintelligence-for-gcms/index.html>
Non-Patent Literature 2: “Convolutional Neural Network,” [online], [searched Apr. 18, 2023], Accelia Inc., Internet <URL: https://www.accelia.net/column/research/1222/>
Non-Patent Literature 3: “Coursera Machine Learning (11): Photo Optical Character Recognition (Photo OCR),” [online], [searched Apr. 18, 2023], Qiita, Inc., Internet <URL: https://qiita.com/katsu1110/items/b43a1ace7c8bbf354864
Non-Patent Literature 4: Olaf Ronneberger, et al., “U-Net: Convolutional Networks for Biomedical Image Segmentation,” [online], [Submitted on 18 May 2015], arXiv.org, Internet <URL: https://arxiv.org/pdf/1505.04597.pdf>

### SUMMARY OF INVENTION

### Technical Problem

Generally, in algorithms widely used for deep learning, the size of the input data to a discriminator using a trained model (hereinafter simply referred to as a “discriminator”) is fixed. For example, in the waveform analysis method described in Patent Literature 1, a chromatogram waveform with a time range of 5 min is divided into 1024 partial waveform data points and then processed by the discriminator. As in the example shown in Non-Patent Literature 1, in waveform processing for an extracted ion chromatogram (a chromatogram corresponding to a specific MRM transition) obtained by multiple reaction monitoring (MRM) measurement using a gas chromatograph-mass spectrometer (GC-MS), the processing target is a chromatogram in a relatively narrow time range before and after the retention time of the compound, which is obtained for each target compound. Therefore, even if the size of the input data to the discriminator is fixed and relatively small as described above, there is substantially no problem.

However, it is difficult to directly apply the waveform processing disclosed in Patent Literature 1 and the like to, for example, an entire chromatogram (e.g., a total ion current chromatogram: TIC) obtained by GC or LC, or an extracted ion chromatogram obtained by selected ion monitoring (SIM) measurement using GC-MS. The main reason for this is that while the input data size of the discriminator is fixed and small to avoid complicating the calculations, the length of a chromatogram such as a TIC varies along the time axis depending on the type of sample, the purpose of the analysis, and so on, meaning it is of variable length, and moreover, the length is often quite long.

An object of the present invention is to provide a waveform analysis method and a waveform analysis apparatus that can accurately detect peaks even for a signal waveform that is of variable length and long, while avoiding the complexity of calculations during the creation of a trained model used in a discriminator and of the arithmetic processing using the discriminator.

### Solution to Problem

One aspect of the waveform analysis method according to the present invention is a waveform analysis method for analyzing a signal waveform that is a chromatogram or a spectrum, the method comprising:
a model creation step of creating a trained model for identifying a peak portion included in an input waveform by machine learning using a plurality of reference waveforms in which the position of the peak portion is known;
a waveform decomposition step of decomposing a target signal waveform to be analyzed into a plurality of processing target waveforms, each having a predetermined data size, so as to cover the entire waveform in a horizontal axis direction;
a region estimation step of dividing each of the plurality of processing target waveforms into a plurality of partial waveforms in the horizontal axis direction, and for each processing target waveform, using the trained model to estimate whether each of the plurality of partial waveforms included in the processing target waveform corresponds to each of a plurality of different types of regions including a peak region and a non-peak region, and obtaining individual region estimation information reflecting the probability of correspondence;
an integration step of integrating the individual region estimation information obtained for each partial waveform of each of the plurality of processing target waveforms in the region estimation step, to obtain region estimation information corresponding to the whole or a part of the target signal waveform; and
a region determination step of using the region estimation information to determine which of the plurality of regions each part in the whole or a part of the target signal waveform is.

One aspect of the waveform analysis apparatus according to the present invention is a waveform analysis apparatus for analyzing a signal waveform that is a chromatogram or a spectrum, the apparatus comprising:
a waveform decomposition unit configured to decompose a target signal waveform to be analyzed into a plurality of processing target waveforms, each having a predetermined data size, so as to cover the entire waveform in a horizontal axis direction;
a region estimation unit configured to divide each of the plurality of processing target waveforms into a plurality of partial waveforms in the horizontal axis direction, and for each processing target waveform, using a trained model created by machine learning using a plurality of reference waveforms in which the position of a peak portion is known for identifying a peak portion included in an input waveform, to estimate whether each of the plurality of partial waveforms included in the processing target waveform corresponds to each of a plurality of different types of regions including a peak region and a non-peak region, and to obtain individual region estimation information reflecting the probability of correspondence;
an integration processing unit configured to integrate the individual region estimation information obtained for each partial waveform of each of the plurality of processing target waveforms in the region estimation unit, to obtain region estimation information corresponding to the whole or a part of the target signal waveform; and
a region determination unit configured to use the region estimation information to determine which of the plurality of regions each part in the whole or a part of the target signal waveform is.

Furthermore, one aspect of the analysis apparatus according to the present invention is any one of a chromatograph apparatus, a mass spectrometer, and an optical measurement apparatus, comprising any aspect of the waveform analysis apparatus according to the present invention as a data analysis unit.

### Advantageous Effects of Invention

According to the above aspects of the waveform analysis method and the waveform analysis apparatus of the present invention, it is possible to accurately perform peak detection for a signal waveform that has a variable and long waveform length in the horizontal axis direction, while using a trained model with a fixed and relatively small input data size.

### BRIEF DESCRIPTION OF DRAWINGS

FIG. 1 is a schematic configuration diagram of an analysis apparatus that implements a waveform analysis method according to an embodiment of the present invention.

FIG. 2 is a flowchart showing the procedure of a trained model creation process in the analysis apparatus of the present embodiment.

FIG. 3 is a flowchart showing the procedure of a peak detection process on a chromatogram waveform to be analyzed in the analysis apparatus of the present embodiment.

FIG. 4 is a waveform diagram showing an example of the relationship between a chromatogram waveform and windows set by a sliding window.

FIG. 5 is a diagram showing the result of performing region estimation on a processing target waveform clipped by window [#1] in FIG. 4.

FIG. 6 is a diagram showing the result of performing region estimation on a processing target waveform clipped by window [#2] in FIG. 4.

FIG. 7 is a diagram showing the result of performing region estimation on a processing target waveform clipped by window [#3] in FIG. 4.

FIG. 8 is a diagram showing the result of integrating the region estimation results shown in FIGS. 5 to 7.

FIG. 9 is a diagram showing regions determined from the integration result shown in FIG. 8.

### DESCRIPTION OF EMBODIMENTS

In the waveform analysis method and the waveform analysis apparatus of the above-described aspects of the present invention, the chromatogram includes chromatograms obtained by a GC apparatus including a gas chromatograph-mass spectrometer (GC-MS), chromatograms obtained by an LC apparatus including a liquid chromatograph-mass spectrometer (LC-MS), as well as electrophoretograms obtained by an electrophoresis apparatus, and the like. In a GC apparatus and an LC apparatus in which the detector is a mass spectrometer, the chromatogram includes a total ion (total ion current) chromatogram and an extracted ion chromatogram. The spectrum includes a mass spectrum (a profile spectrum that has not been subjected to centroid processing) obtained by a mass spectrometer, a time-of-flight spectrum before being converted into a mass spectrum obtained by a time-of-flight mass spectrometer, a light intensity spectrum obtained by an optical measurement apparatus such as a spectrophotometer or a fluorescence measurement apparatus, an X-ray intensity spectrum obtained by an X-ray analysis apparatus, and the like.

### System Overview of an Embodiment

Hereinafter, a GC system as one embodiment of an analysis apparatus including a waveform analysis apparatus in which the waveform analysis method according to the present invention is implemented will be described with reference to the accompanying drawings.

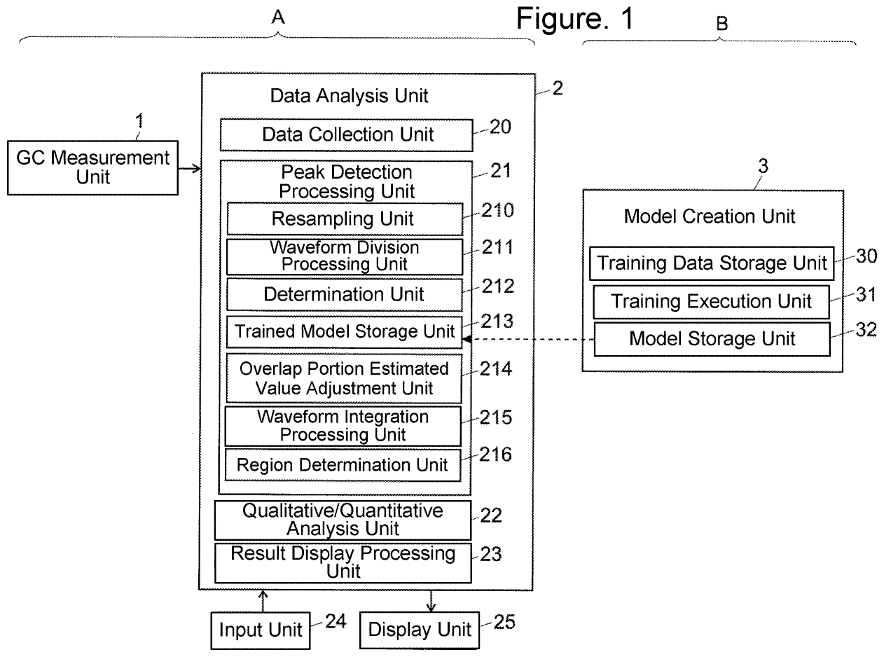

FIG. 1 is a schematic configuration diagram of a GC system A of the present embodiment and a system B for creating a trained model used in the system.

The GC system A in the present embodiment includes a GC measurement unit 1, a data analysis unit 2, an input unit 24, and a display unit 25. Although not shown, the GC measurement unit 1 includes an injector, a column, a column oven, a detector, and the like, executes GC analysis on a given sample, and acquires chromatogram data indicating the temporal change in signal intensity obtained by the detector. The type and method of the detector are not particularly limited, but for example, a mass spectrometer, a flame ionization detector, a barrier discharge ionization detector, or the like can be used.

The data analysis unit 2 includes functional blocks such as a data collection unit 20, a peak detection processing unit 21, a qualitative/quantitative analysis unit 22, and a display processing unit 23. The peak detection processing unit 21 includes functional blocks such as a resampling unit 210, a waveform division processing unit 211, a determination unit 212, a trained model storage unit 213, an overlap portion estimation value adjustment unit 214, a waveform integration processing unit 215, and a region determination unit 216.

In the data analysis unit 2, the data collection unit 20 collects and stores the chromatogram data obtained by the GC measurement unit 1. In response to an instruction received from a user via the input unit 24, the peak detection processing unit 21 automatically detects peaks in the chromatogram waveform constituted by the collected chromatogram data, and outputs peak information including the start position and end position (retention time) of the detected peaks, the range of the peak region, and the like. The qualitative/quantitative analysis unit 22 identifies the component (compound) corresponding to each peak based on the peak information provided from the peak detection processing unit 21, calculates peak height values and peak area values, and calculates quantitative values, which are the concentration or content of each component, from those values. The display processing unit 23 displays the peak detection results and calculated values such as quantitative values calculated based thereon on the display unit 25 in a predetermined format.

Generally, the data analysis unit 2 is embodied as a personal computer or a higher-performance workstation on which predetermined software (a computer program) is installed, or a computer system including such a computer connected via a communication line to a high-performance computer. That is, the functions of each block included in the data analysis unit 2 are realized by executing the software installed in a single computer or a computer system including a plurality of computers on that computer. Of course, a part of these functions may be executed using a hardware circuit specialized for specific calculations, such as a digital signal processor.

The computer program can be provided to the user stored in a non-transitory computer-readable storage medium, such as a CD-ROM, a DVD-ROM, a memory card, or a USB memory (dongle). The program can also be provided to the user in the form of data transfer via a communication line such as the Internet. Furthermore, the program can be pre-installed in a computer (strictly speaking, a storage device that is part of the computer) that is part of the system at the time the user purchases the system.

In FIG. 1, a system B provided separately from the GC system A includes a model creation unit 3, and the model creation unit 3 includes a training data storage unit 30, a training execution unit 31, and a model storage unit 32 as functional blocks. The trained model created in this model creation unit 3 is stored in the trained model storage unit 213 in the data analysis unit 2 of the GC system A.

As will be described in detail later, the work of creating a trained model generally requires a huge amount of calculation. Therefore, the system B is embodied as a high-performance computer, and the functions of each block are realized by executing software installed in the computer on that computer. Of course, the system B may be integrated with the GC system A.

Next, the peak detection process executed mainly by the peak detection processing unit 21 of the data analysis unit 2 will be described.

Very briefly, the peak detection processing unit 21 forms a one-dimensional (or two-dimensional) data array of the chromatogram waveform constituted by the chromatogram data, and then detects the position or range of a peak region, a peak start region, a peak end region, a non-peak region, etc., by using a semantic segmentation method with deep learning, which is a machine learning technique for detecting the category and position of an object present in an image.

### Processing During Creation of Trained Model

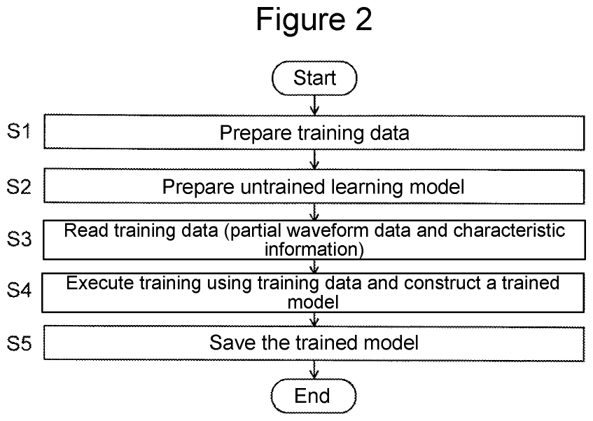

As is well known, in a machine learning method, it is necessary to build a trained model in advance using a large amount of training data (training data and validation data). As described above, the work of building this trained model is not performed in the data analysis unit 2, which is part of the GC system A, but is performed by the model creation unit 3 constituted by a separate computer system, and the result is stored in the trained model storage unit 213. FIG. 2 is a flowchart showing a schematic procedure of the trained model creation process performed in the model creation unit 3.

When creating a trained model, first, training data based on a reference waveform is prepared (step S1). Here, a large number of diverse chromatogram waveforms are used as reference waveforms. The diverse chromatogram waveforms here are preferably chromatogram waveforms including various factors that may appear in the chromatogram waveform during actual peak detection, such as the mixing of various noises, baseline fluctuation (drift), overlapping of a plurality of peaks, or deformation of a peak shape. However, this chromatogram waveform data does not have to be data collected by actual GC analysis, and may be data created by simulation.

For the chromatogram waveform which is a reference waveform, peak detection is performed in advance, for example, by a skilled person, and the start point and end point of one or more peaks on the waveform are accurately determined. This chromatogram waveform is converted into a one-dimensional data array with the signal intensity, that is, the vertical axis in the graph, being normalized, and is further divided into a predetermined number of partial waveforms in the horizontal axis direction, that is, the time axis direction. This number of divisions is determined so that the width (length in the time axis direction) of each partial waveform is at least smaller than the peak width. Therefore, the number of divisions can be appropriately set according to the minimum value of the assumed peak width.

One chromatogram waveform (reference waveform) is composed of many partial waveforms. The data constituting each partial waveform is associated with characteristic information indicating which of a plurality of types of regions the partial waveform corresponds to. For example, a partial waveform corresponding to a peak portion on the chromatogram waveform is associated with characteristic information indicating a peak region, a partial waveform including a peak start point is associated with characteristic information indicating a peak start region, and a partial waveform not including any peak portion is associated with characteristic information indicating a non-peak region (baseline region). There are at least four types of regions: a peak region, a peak start region, a peak end region, and a non-peak region. The peak region may be divided into a single peak region where only one peak exists (no overlap with other peaks) and an overlapping peak region where a plurality of peaks overlap, depending on the state of the peak in the peak portion. The overlapping peak region can be further subdivided as described later. The training data storage unit 30 stores, in a collective manner, partial waveform data constituting a large number of chromatogram waveforms and the characteristic information associated therewith. The training data may be divided into training data and validation data in advance, or may not be so divided and may be used as either training data or validation data as appropriate during training execution.

When the start of creating a learning model is instructed, the training execution unit 31 prepares an untrained learning model (step S2). Various models capable of executing semantic segmentation can be used for this learning model. Semantic segmentation is generally used to analyze an image composed of pixel data distributed two-dimensionally, but here it is applied to the analysis of a chromatogram waveform composed of data arranged one-dimensionally along the time axis. As a learning model capable of executing semantic segmentation, U-Net (see Non-Patent Literature 4) is used here, but other learning models such as SegNet or PSPNet may be used.

Next, the training execution unit 31 reads the training data (partial waveform data and characteristic information) from the training data storage unit 30 (step S3). The training execution unit 31 performs machine learning using the read training data and constructs a learning model for estimating which region a given partial waveform corresponds to (step S4). The learning procedure is not described in detail here, but a trained model can be constructed according to a known procedure, for example, as described in Patent Literature 1.

The model storage unit 32 saves the trained model created by machine learning using a large amount of training data (step S5). The trained model saved in the model storage unit 32 is transmitted, for example, via a communication line and stored in the trained model storage unit 213 in the GC system A.

### Peak Detection Process for Target Signal Waveform

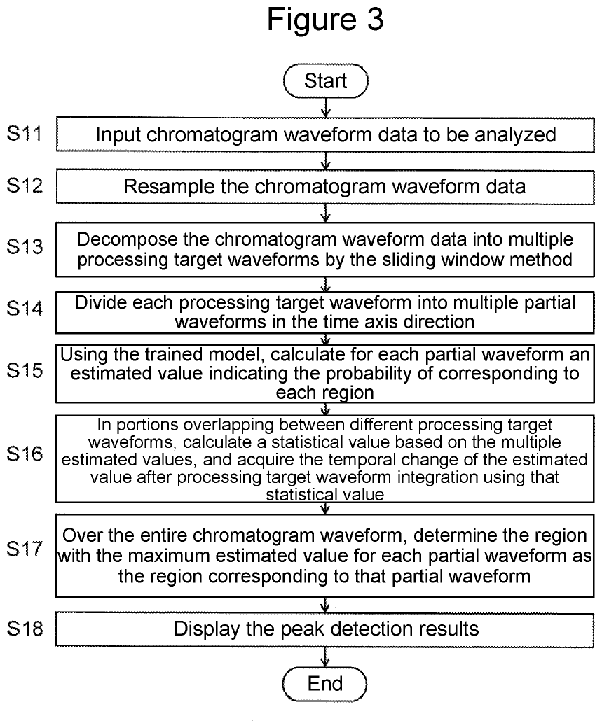

Next, the process of detecting peaks on a chromatogram waveform obtained for a target sample, which is executed by the data analysis unit 2 in the GC system A, will be described. FIG. 3 is a flowchart showing a schematic flow of the peak detection process performed in the peak detection processing unit 21.

First, the resampling unit 210 reads the chromatogram waveform (target signal waveform) data to be analyzed from the data collection unit 20 (step S11). For example, when the GC measurement unit 1 is a GC-MS, this chromatogram is a total ion current chromatogram, or an extracted ion chromatogram by SIM measurement or MRM measurement. The length of this chromatogram waveform in the time direction depends on the measurement time and measurement conditions at the time of data acquisition. Therefore, its length varies and can be said to be of variable length. The resampling unit 210 resamples the read chromatogram waveform data at a specified sampling interval (step S12).

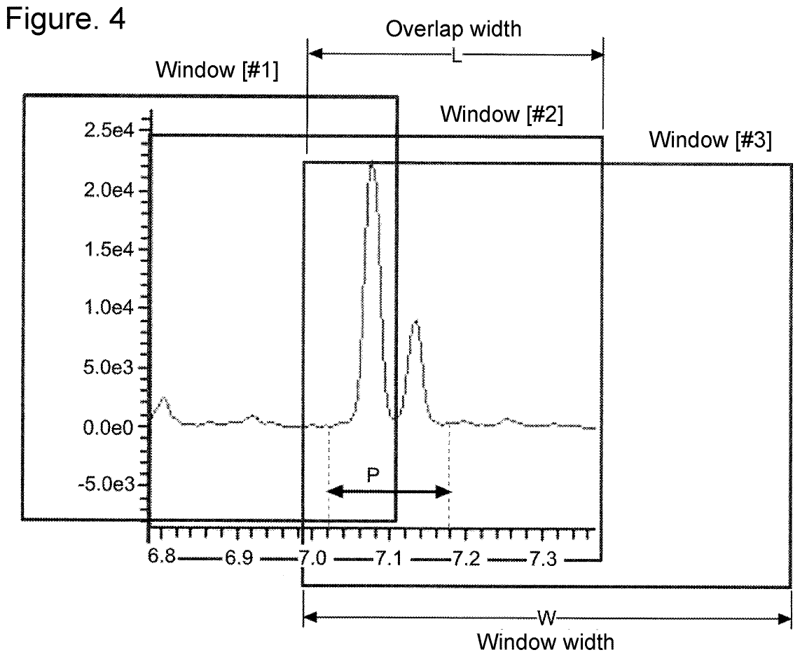

The sampling interval during this resampling is determined by the time width of the waveform clipped by one window, which will be described later, and the data size input to the trained model. In the example of FIG. 4 described later, the chromatogram waveform is resampled so that there are 1024 points, which is the input data size of the U-Net-based trained model, per 1.5 minutes of time. Particularly when the GC measurement unit 1 acquires chromatogram data by measurement, the sampling interval of the data is not necessarily constant, nor is the sampling interval the same for each measurement. This is because, for example, when performing SIM measurement (or MRM measurement) in a GC-MS, the sampling interval may change depending on the measurement conditions such as the number of SIM measurements performed in the same time period, and even in the case of scan measurement, it may change depending on measurement conditions such as the scan m/z range and scan speed. In contrast, by performing resampling, the sampling interval can be made constant over the entire chromatogram, regardless of the sampling state of the original chromatogram waveform data.

Next, the waveform division processing unit 211 applies a sliding window method to the resampled chromatogram waveform data in the time axis direction, and decomposes it into a plurality of processing target waveforms each having a predetermined window width (step S13).

As described in Non-Patent Literature 2, 3, etc., the sliding window method is one of the methods for decomposing (dividing) an image into a size suitable for processing by a deep learning discriminator. Here, this sliding window method is applied to the processing of a signal waveform. Specifically, by using the sliding window method, a window corresponding to each processing target waveform is set such that at least a part of two or more processing target waveforms that are continuous in the time direction overlap. When decomposing the original chromatogram waveform into a plurality of processing target waveforms, it is also possible to adopt a method of setting two windows adjacent in the time direction so that they do not overlap and there is no gap between them. However, as will become clear in the later description, when a part of a waveform is clipped from a continuous waveform and the region of the clipped waveform is determined using a trained model, the accuracy of the determination at the ends of the clipped waveform, that is, near the joints with other adjacent waveforms, tends to decrease. In contrast, by causing at least a part of two or more continuous processing target waveforms to overlap, it is possible to determine regions such as peak regions based on the determination results for a plurality of different processing target waveforms in the overlap portion. This can improve the accuracy of determination at the ends of the processing target waveform.

The width of the window and the overlap width of adjacent windows can be appropriately determined in advance according to the shape of the signal waveform, measurement conditions, data processing conditions, etc., that are anticipated beforehand. Specifically, they should preferably be determined appropriately based on parameters such as the input data size of the trained model, the analysis time (the rate of increase in analysis time increases as the waveform becomes longer), the peak width (usually the assumed maximum and minimum peak widths), and the sampling rate. For example, the overlap width is preferably set to be wider than the assumed maximum peak width.

Furthermore, it is preferable that the width of the window and the overlap width are determined such that three or more windows overlap near the center in the time axis direction of the processing target waveform. Also, so that at least two or more windows overlap even at both ends of the chromatogram waveform, the window including the end of the chromatogram waveform may be set to protrude into the region outside the waveform, that is, into a region where no waveform exists.

FIG. 4 is a waveform diagram showing an example of the relationship between a chromatogram waveform and windows set by a sliding window. In this example, three windows, [#1], [#2], and [#3], cover the entire chromatogram waveform. The window width is W, and the overlap width is L. As described above, the leftmost window [#1] including the left end of the waveform protrudes to the left of the waveform, and the rightmost window [#3] including the right end of the waveform protrudes to the right of the waveform. In this example, three windows overlap in the portion near the center of the chromatogram waveform, and two windows overlap in the other portions. It should be noted that appropriate dummy data may be inserted in the parts within the window where no waveform exists, that is, where no data actually exists.

The waveform division processing unit 211, for each of the plurality of processing target waveforms clipped for each window as described above, normalizes the signal intensity information, converts it into a one-dimensional data array, and divides the waveform data into a predetermined number of partial waveforms in the horizontal axis (time axis) direction (step S14). This number of divisions may be the same as the number of divisions in the training data, but it may be a different number as long as the width of the partial waveform is smaller than the peak width.

Subsequently, the determination unit 212 reads the trained model from the trained model storage unit 213, and for each processing target waveform, sequentially inputs the plurality of partial waveforms constituting one processing target waveform into the trained model. The trained model determines whether the input partial waveform corresponds to each region, such as a peak region, a peak start region, a peak end region, or a non-peak region. Specifically, here, the determination unit 212 uses the trained model to calculate a numerical value indicating the probability of corresponding to each region for each partial waveform as an estimated value (step S15). The larger the value of this estimated value, the higher the probability that the partial waveform is that region. In this way, from the determination unit 212, for all the processing target waveforms clipped from the original chromatogram waveform, an estimated value for each region, such as a peak region or a peak start region, is assigned to all the partial waveforms constituting each processing target waveform and output.

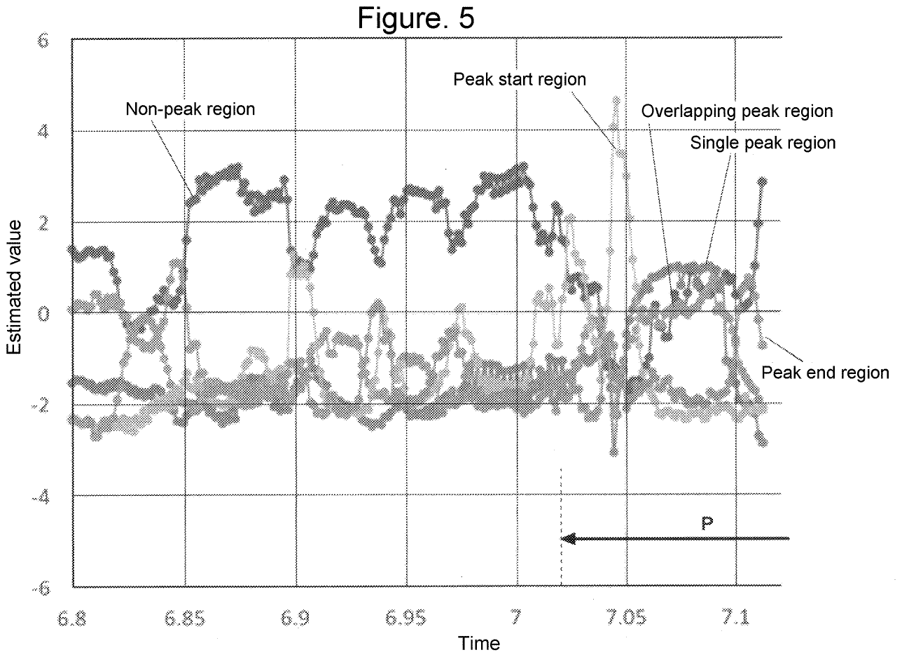

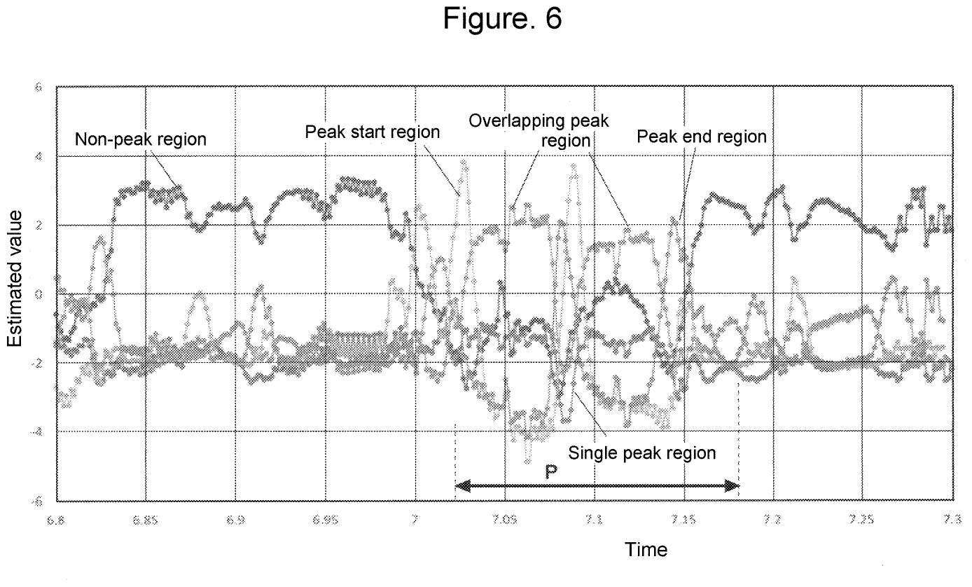

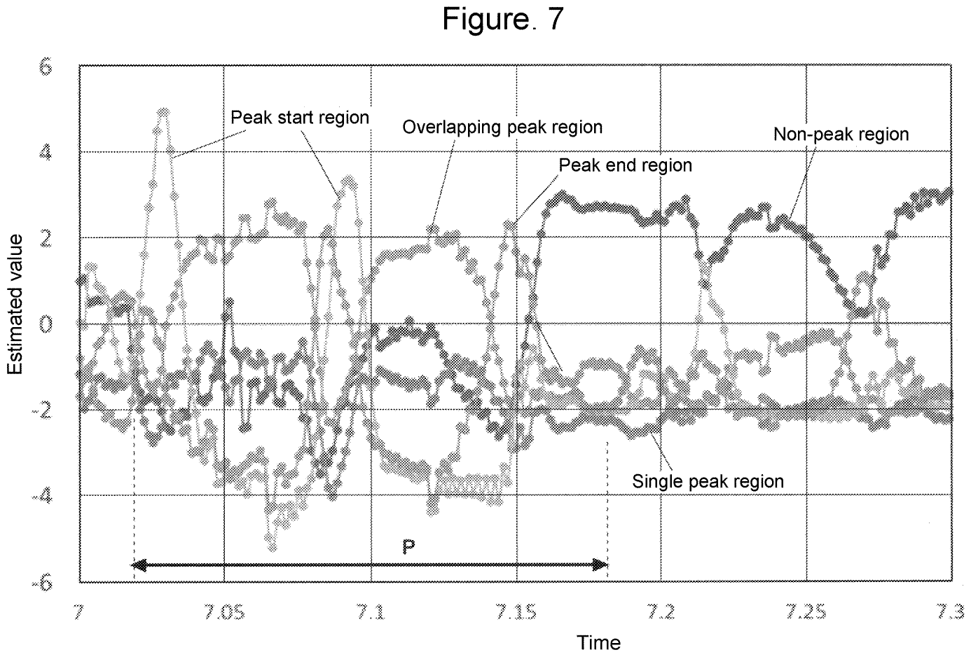

FIGS. 5 to 7 are diagrams each showing the result of performing the region estimation process in the above step S15 on the processing target waveform clipped by window [#1], [#2], and [#3] in FIG. 4, respectively. In this example, the peak region is divided into a single peak region and an overlapping peak region as described above, and the number of region types is five. Also, the time range where a peak approximately exists in FIG. 4 is indicated by P, and the same time range is indicated by Pin FIGS. 5 to 7. As shown in FIGS. 5 to 7, the determination result by the determination unit 212 using the trained model shows the temporal change of the estimated value for each of the five regions: single peak region, overlapping peak region, peak start region, peak end region, and non-peak region. As described above, at any point in time of the original chromatogram waveform, two or more windows overlap, and in that overlap portion, the same number of pieces of estimated value information as the number of overlapping windows is obtained. The estimation result of the region in the processing target waveform differs depending on the shape of the waveform. Therefore, the information of the estimated value in the overlap portion obtained from different windows is usually not the same. In the simplest example, in the vicinity of time 7.05-7.08 of window [#1] shown in FIG. 5, the estimated value of the single peak region is higher than the estimated value of the overlapping peak region, but in the vicinity of time 7.05-7.08 of window [#2] shown in FIG. 6 and window [#3] shown in FIG. 7, the estimated value of the overlapping peak region is significantly higher than the estimated value of the single peak region. This is presumed to be because, in the processing target waveform clipped by window [#1], the second peak of the overlapping peak is cut off (only a part is included).

The estimation result of the region, particularly near both ends of the processing target waveform, differs greatly depending on how the waveform is interrupted (whether the entire peak is included in the processing target waveform, or only a part of the peak is included in the processing target waveform). Therefore, in the system of this embodiment, utilizing the fact that a plurality of independent estimated values are obtained from a plurality of different windows in the overlap portion, a statistical process is performed based on the plurality of estimated values for the same region to calculate a statistical value, and that statistical value is used as the estimated value in the overlap portion. That is, the overlap portion estimation value adjustment unit 214 acquires an estimated value for each region from a plurality of different windows in the overlap portion, and obtains one statistical value by a predetermined statistical process from the plurality of estimated values for each region. A very simple process can be adopted as the statistical process here, and specifically, any one of the maximum value, minimum value, average value, median value, or mode value can be adopted as the statistical value. Through the process of step S15, the plurality of estimated values for each region are integrated into one statistical value for each region.

The waveform integration processing unit 215 integrates the estimated values for each region corresponding to each of the plurality of processing target waveforms, uses the above statistical value for the overlap portions, and calculates information on the temporal change of the estimated value for each region corresponding to the entire original chromatogram waveform (step S16). It should be noted that information on the temporal change of the estimated value for each region may be calculated only for a part of the waveform desired by the user, instead of the entire chromatogram waveform.

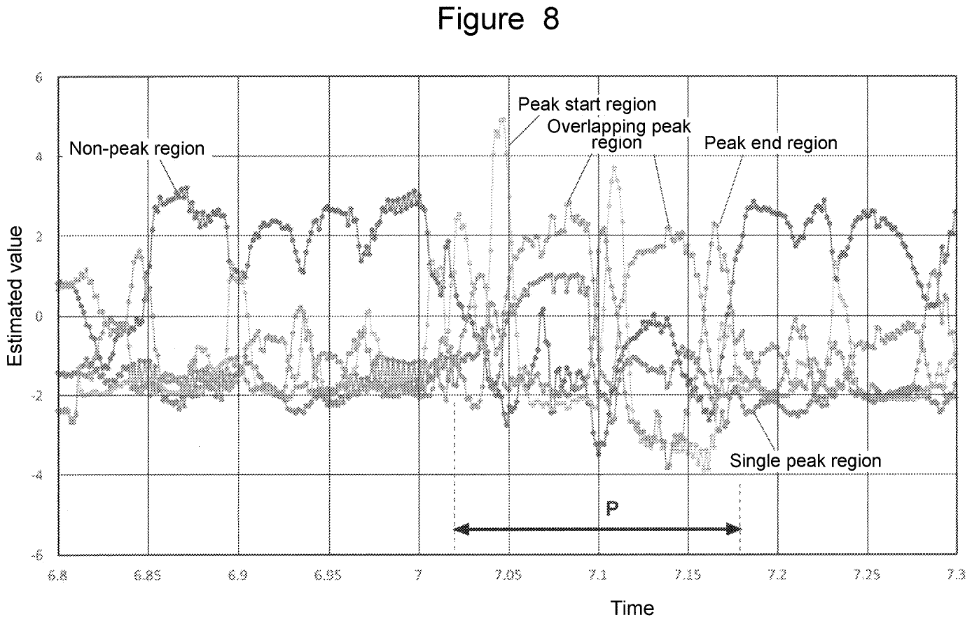

FIG. 8 is a diagram showing the result of integrating the region estimation results shown in FIGS. 5 to 7. In this example, as the statistical value, the minimum value among a plurality of estimated values is used for the non-peak region, and the maximum value among a plurality of estimated values is used for regions other than the non-peak region, that is, the single peak region, the overlapping peak region, the peak start region, and the peak end region. This is for the purpose of minimizing missed peaks, by preferentially adopting a determination result indicating that there is even a slight possibility of a peak. Since such values are adopted as statistical values, in the vicinity of the time 7.05-7.08 mentioned above, the estimated value for the overlapping peak region is higher than the estimated value for the single peak region, and the estimation result in window [#1] is substantially not reflected.

The region determination unit 216 receives the output from the waveform integration processing unit 215, and over the entire chromatogram waveform, determines that the region showing the highest estimated value for each partial waveform is the region corresponding to that partial waveform, and determines the region corresponding to each partial waveform (step S17). As a result, all the partial waveforms constituting the entire chromatogram waveform are classified into one of the regions.

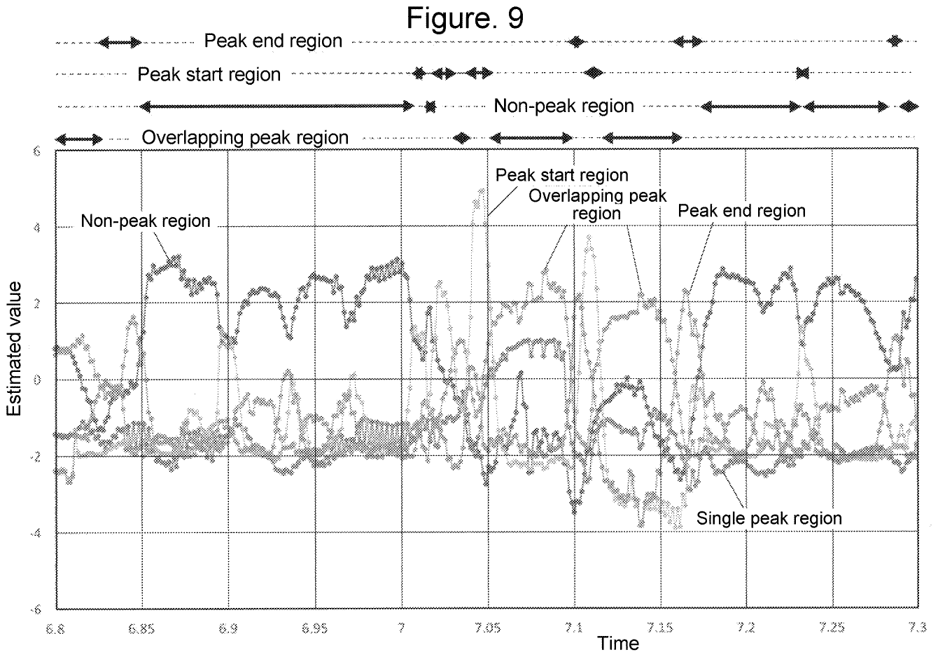

FIG. 9 is a diagram showing the integration result shown in FIG. 8 together with the regions determined thereby. The overlapping peak region, non-peak region, peak start region, and peak end region are each indicated by a double-headed arrow with a thick line. The peak portion indicated by P in FIG. 4 is estimated in sequence as peak start region→overlapping peak region→peak end region→peak start region→overlapping peak region→peak end region as time elapses, and the overlapping peak is accurately detected.

Thereafter, the display processing unit 23 displays the peak detection result by the peak detection processing unit 21 on the screen of the display unit 25 (step S18). If the setting is such that qualitative analysis is automatically executed based on the peak detection result, the qualitative/quantitative analysis unit 22 obtains, for example, the retention time of the peak top for each detected peak, and identifies the component corresponding to the peak based on the retention time. If the setting is such that quantitative analysis is automatically executed based on the peak detection result, the qualitative/quantitative analysis unit 22 obtains the peak area value or height value for each detected peak, and calculates the concentration (content) of the component corresponding to the peak by comparing the area value or height value with a previously created calibration curve. The display processing unit 23 displays the results of such qualitative analysis or quantitative analysis together with the peak detection result on the screen of the display unit 25.

As described above, in the GC system of the present embodiment, peaks can be detected with high accuracy for chromatograms of various time lengths acquired by GC measurement, and accurate peak information can be provided to the user.

In the above description, the minimum value was used as the statistical value for the non-peak region, and the maximum value was used for regions other than the non-peak region. However, as the statistical value, any one of the maximum value, minimum value, average value, median value, or mode value based on a plurality of estimated values can be appropriately selected. This selection may be predetermined and unchangeable by the user, or it may be configured so that the user can select it appropriately from the input unit 24.

Generally, the types of statistical values can be used differently as follows. As described above, if the minimum value is used as the statistical value for the non-peak region and the maximum value is used for regions other than the non-peak region, the possibility of erroneously determining noise as a peak becomes relatively high, but a small-intensity peak that tends to be missed can be detected as a peak. Therefore, this selection is useful when it is desired to detect peaks as completely as possible.

Furthermore, for example, if the average value, median value, or mode value is used as the statistical value, the possibility of missing a small-intensity peak becomes relatively high, but the possibility of erroneously determining noise as a peak becomes low. Therefore, such a selection is useful when it is desired to detect only those with a high probability of being a peak. However, for the median value and mode value, it is difficult to obtain sufficient accuracy unless the number of estimated values is a certain number or more, at least 3 or more, and preferably 5 or more. Therefore, when it is desired to use such statistical values, it is advisable to widen the overlap width during the sliding window (bring it closer to the window width).

### Description of Various Additional Configurations

Next, some preferable additional configurations in the apparatus of the above embodiment will be described. The configurations described below can be appropriately combined with those described in the above embodiment. It is also possible to combine a plurality of additional configurations as long as they do not perform contradictory processes.

In the above embodiment, a region where a plurality of peaks overlap was simply referred to as an overlapping peak region. However, when determining the concentration or content of a compound from the area or height of a peak, a process of dividing the overlapping peak into a plurality of peaks is necessary. Several methods are known for peak division, and the appropriate division method differs depending on how the peaks overlap, etc.

Specifically, for the division of an overlapping peak, for example, methods such as tailing processing, which divides the peak into two by treating the range from the start point to the end point of the target peak as one peak and superimposing another peak on it; complete separation, which separates the peak into two by sequentially connecting the start point, the local minimum point, and the end point of the target peak; and vertical division, which separates the peak into two by a perpendicular line passing through the local minimum point of the target peak, are used. Therefore, it is also possible to set the regions by dividing the overlapping peak region into three: a vertical division peak region, a complete separation peak region, and a tailing processing peak region. In this case, a trained model may be created by machine learning using a plurality of sets, each set consisting of a plurality of partial waveforms created by dividing a reference waveform including an overlapping peak separated by each method of tailing processing, complete separation, and vertical division along the time axis.

In the above embodiment, the determination unit 212 using the trained model performed region estimation for each partial waveform, such as a non-peak region or a single peak region, and obtained an estimated value. However, it is possible to adjust the estimated value itself, or to change the rule for determining the region in the above step S17, by using numerical information reflecting the shape and characteristics of the peak in a range corresponding to the peak region, for example. The numerical information reflecting the shape and characteristics of the peak that can be used here includes the S/N ratio, the degree of separation of the peak, the symmetry factor, the proportion of peak clipping, the peak height, or the peak width.

For example, even if the estimated value corresponding to a peak region (single peak region or overlapping peak region) is large, if the S/N ratio calculated from the signal intensities in the peak region and the non-peak region is a predetermined threshold (e.g., 10) or less, there is a high possibility that noise is being recognized as a peak, and the reliability of the peak detection result itself is low. Therefore, when the S/N ratio of a partial waveform is a predetermined threshold or less, it is conceivable to adjust by lowering the estimated value for the peak region corresponding to that partial waveform by a predetermined value, or by raising the estimated value for the non-peak region by a predetermined value.

For example, the symmetry factor is an index indicating the left-right symmetry of a peak, but if the peak's left-right symmetry is poor, there is a possibility that a small peak is riding on the tail of a large peak. Therefore, when the symmetry factor is larger than a predetermined threshold, even if the estimated value for the single peak region corresponding to that peak portion is large, or the estimated value for the overlapping peak region is small, the estimated value for the overlapping peak region may be adjusted to be larger over the entire peak portion.

Regarding the degree of separation, the Japanese Pharmacopoeia states that complete separation is achieved when it is 1.5 or more. Therefore, based on this degree of separation, the estimated values for the complete separation peak region, the tailing processing peak region, and the vertical separation peak region can be appropriately adjusted. Also, if a peak exists at the end of a chromatogram and a part of that peak is missing, if the proportion of the missing part is small, there is no problem for quantification, but if the proportion of the missing part is large, it is unsuitable for quantification. Therefore, when the proportion of the missing part is large, it is possible to not detect it as a peak (to increase the estimated value for the non-peak region).

It is also possible to calculate the slope of the baseline based on the partial waveform determined as a non-peak region, and to use that numerical value to change the region estimation result, etc. Specifically, if the baseline slope changes from a large positive value to a small value over time, it is assumed that the baseline is in an upwardly convex state. In this case, even if the overlapping peak existing on such a baseline is a vertical division peak region, since the bottom of the valley of the overlapping peak can be estimated to be in contact with the baseline, the estimated value for the complete separation peak region can be increased.

When making a determination by comparing a numerical value reflecting the peak shape and characteristics or a numerical value reflecting the baseline shape with a threshold, it is advisable to allow the threshold to be set from the input unit 24. This allows the user to appropriately change the criteria for changing regions according to the analysis purpose, the type of sample, etc.

In the above embodiment, a predetermined type of statistical value or a type of statistical value selected by the user was used as the statistical value used in step S16. However, it is possible to automatically select the type of statistical value to be used according to various factors. It is also possible not only to calculate the statistical value from a plurality of estimated values for each region for each partial waveform in the overlap portion of a plurality of windows, but also to correct or adjust the statistical value according to various factors other than the estimation using the trained model.

For example, compound information regarding the target compound in the sample, which can be known in advance, can also be used for selecting the type of statistical value or for adjusting the statistical value itself. The compound information here can include, for example, in addition to information on the compound itself such as its concentration, structural information such as whether an isomer of the compound exists, and information such as whether a derivative generated in the pretreatment process exists.

For example, if it is known that the concentration of a compound in a sample is high, the signal intensity of the peak corresponding to the compound should be high and the S/N ratio should also be good. Therefore, since the possibility of misidentifying noise as a peak is low, it is possible to use the maximum value as the statistical value for the non-peak region in the overlap portion. If it is known as compound information that an isomer of the target compound exists, an overlapping peak with a slight time shift is likely to appear on the chromatogram because isomers have the same molecular weight but differ in structure, etc. Therefore, for the peak estimated to correspond to the target compound, it is advisable to make an adjustment to reduce the estimated value for the single peak region, thereby making it easier to determine that it is an overlapping peak region.

In a mass spectrometer, it is usually possible to observe multiple types of ions (called quantitation ions and confirmation ions) with different m/z values generated from a single component. Therefore, in GC-MS and LC-MS, it is possible to create an extracted ion chromatogram for the quantitation ion and one or more extracted ion chromatograms for the confirmation ions for the same component. Here, the peak detection process described above may be performed on at least one of these chromatograms. However, since the extracted ion chromatograms for the quantitation ion and the confirmation ion are chromatograms derived from the same component, their waveforms should be similar. Therefore, it is also conceivable to compare the region estimation result in the chromatogram for the quantitation ion for the same component with the region estimation result in the chromatogram for the confirmation ion, and to adjust the region estimation result based on the comparison result.

It is also possible to compare the region estimation results in signal waveforms such as chromatograms or spectra obtained for an unknown sample containing the same target component and a standard sample containing the target component at a known concentration, or to additionally use the region estimation result in a signal waveform such as a chromatogram or a spectrum obtained for a blank sample not containing the target component.

The above-described embodiment and modified examples are all merely examples, and can be appropriately modified in accordance with the spirit of the present invention. In the above embodiment, the waveform analysis apparatus for performing peak detection is incorporated as part of the same GC system A as the measurement unit, but it can be configured as a waveform analysis apparatus independent of the GC system A. In that case, the analysis can be performed by reading the chromatogram data previously acquired by the GC measurement unit 1.

Although the above embodiment has been described by taking the case of processing a chromatogram waveform as an example, it is clear that the present invention is applicable to the waveform analysis of signal waveforms obtained by various analysis apparatuses, such as an electrophoretogram obtained by an electrophoresis apparatus, a mass spectrum (profile spectrum) obtained by a mass spectrometer, a spectral spectrum obtained by a spectrophotometer, a fluorescence spectrum obtained by a fluorescence measurement apparatus, and an X-ray intensity spectrum obtained by an X-ray analysis apparatus, in which the signal intensity can change according to the change in the value of a predetermined parameter.

### Various Aspects

It is understood by those skilled in the art that the exemplary embodiments described above are specific examples of the following aspects.

(Item 1) One aspect of the waveform analysis method according to the present invention is a waveform analysis method for analyzing a signal waveform that is a chromatogram or a spectrum, the method comprising:
a model creation step of creating a trained model for identifying a peak portion included in an input waveform by machine learning using a plurality of reference waveforms in which the position of the peak portion is known;
a waveform decomposition step of decomposing a target signal waveform to be analyzed into a plurality of processing target waveforms, each having a predetermined data size, so as to cover the entire waveform in a horizontal axis direction;
a region estimation step of dividing each of the plurality of processing target waveforms into a plurality of partial waveforms in the horizontal axis direction, and for each processing target waveform, using the trained model to estimate whether each of the plurality of partial waveforms included in the processing target waveform corresponds to each of a plurality of different types of regions including a peak region and a non-peak region, and obtaining individual region estimation information reflecting the probability of correspondence;
an integration step of integrating the individual region estimation information obtained for each partial waveform of each of the plurality of processing target waveforms in the region estimation step, to obtain region estimation information corresponding to the whole or a part of the target signal waveform; and
a region determination step of using the region estimation information to determine which of the plurality of regions each part in the whole or a part of the target signal waveform is.

(Item 13) One aspect of the waveform analysis apparatus according to the present invention is a waveform analysis apparatus for analyzing a signal waveform that is a chromatogram or a spectrum, the apparatus comprising:
a waveform decomposition unit configured to decompose a target signal waveform to be analyzed into a plurality of processing target waveforms, each having a predetermined data size, so as to cover the entire waveform in a horizontal axis direction;
a region estimation unit configured to divide each of the plurality of processing target waveforms into a plurality of partial waveforms in the horizontal axis direction, and for each processing target waveform, using a trained model created by machine learning using a plurality of reference waveforms in which the position of a peak portion is known for identifying a peak portion included in an input waveform, to estimate whether each of the plurality of partial waveforms included in the processing target waveform corresponds to each of a plurality of different types of regions including a peak region and a non-peak region, and to obtain individual region estimation information reflecting the probability of correspondence;
an integration processing unit configured to integrate the individual region estimation information obtained for each partial waveform of each of the plurality of processing target waveforms in the region estimation unit, to obtain region estimation information corresponding to the whole or a part of the target signal waveform; and
a region determination unit configured to use the region estimation information to determine which of the plurality of regions each part in the whole or a part of the target signal waveform is.

According to the waveform analysis method described in Item 1 and the waveform analysis apparatus described in Item 13, it is possible to accurately perform peak detection for a signal waveform that has a variable and long waveform length in the horizontal axis direction, while using a trained model with a fixed and relatively small input data size.

(Item 2) In the waveform analysis method according to Item 1,
the waveform decomposition step may acquire a plurality of processing target waveforms in which at least a part of the range overlaps with other processing target regions by applying a sliding window method to the target signal waveform in the horizontal axis direction, and
the integration step may obtain integrated region estimation information based on the individual region estimation information obtained for each of the overlapping ranges of the plurality of processing target waveforms in the range where the plurality of processing target waveforms overlap.

(Item 14) In the waveform analysis apparatus according to Item 13,
the waveform decomposition unit may acquire a plurality of processing target waveforms in which at least a part of the range overlaps with other processing target regions by applying a sliding window method to the target signal waveform in the horizontal axis direction, and
the integration processing unit may obtain integrated region estimation information based on the individual region estimation information obtained for each of the overlapping ranges of the plurality of processing target waveforms in the range where the plurality of processing target waveforms overlap.

When performing region determination using a trained model for a processing target waveform clipped from a continuous waveform by a window, the accuracy of the determination at the ends of the clipped processing target waveform, that is, near the joints with other adjacent processing target waveforms, tends to decrease. According to the waveform analysis method described in Item 2 and the waveform analysis apparatus described in Item 14, since the end of a processing target waveform clipped by one window becomes an overlap portion, region determination can be performed based on the determination results for a plurality of different processing target waveforms in that overlap portion, and the accuracy of region determination at the ends of the processing target waveform can be improved.

(Item 3) In the waveform analysis method according to Item 2,
the individual region estimation information may be an estimated value reflecting the probability of corresponding to each region, and
the integration step may obtain a statistical value by a statistical process from the estimated values obtained for each corresponding partial waveform for each of the overlapping ranges of the plurality of processing target waveforms in the range where the plurality of processing target waveforms overlap.

(Item 4) In the waveform analysis method according to Item 3, the statistical value may include one of a maximum value, a minimum value, a median value, an average value, or a mode value.

(Item 15) In the waveform analysis apparatus according to Item 14,
the individual region estimation information may be an estimated value reflecting the probability of corresponding to each region, and
the integration processing unit may obtain a statistical value by a statistical process from the estimated values obtained for each corresponding partial waveform for each of the overlapping ranges of the plurality of processing target waveforms in the range where the plurality of processing target waveforms overlap.

(Item 16) In the waveform analysis apparatus according to Item 15, the statistical value may include one of a maximum value, a minimum value, a median value, an average value, or a mode value.

According to the waveform analysis method described in Items 3 and 4, and the waveform analysis apparatus described in Items 15 and 16, since the region estimation is performed based on a statistical value calculated from a plurality of estimated values, a highly reliable and reproducible estimation based on a quantitative basis is possible.

(Item 5) In the waveform analysis method according to Item 4, the integration step may use a minimum value as the statistical value for a non-peak region and a maximum value as the statistical value for regions other than the non-peak region, in the range where the plurality of processing target waveforms overlap.

(Item 17) In the waveform analysis apparatus according to Item 16, the integration processing unit may use a minimum value as the statistical value for a non-peak region and a maximum value as the statistical value for regions other than the non-peak region, in the range where the plurality of processing target waveforms overlap.

According to the waveform analysis method described in Item 5 and the waveform analysis apparatus described in Item 17, a partial waveform that may be a peak can be extracted as a peak region. Therefore, although the possibility of erroneously estimating a non-peak as a peak region increases, it is possible to estimate even a peak with a subtle shape or size that might be missed in the past as a peak region, thereby reducing missed peaks and detection omissions.

(Item 6) The waveform analysis method according to Item 4 or 5 may further comprise a statistical value determination step of determining the type of statistical value to be used in the range where the plurality of processing target waveforms overlap in the integration step, based on a user's instruction.

(Item 18) The waveform analysis apparatus according to Item 16 or 17 may further comprise a statistical value setting unit configured to determine the type of statistical value to be used in the range where the plurality of processing target waveforms overlap in the integration processing unit, based on a user's instruction.

According to the waveform analysis method described in Item 6 and the waveform analysis apparatus described in Item 18, the user can appropriately select the type of statistical value to be used according to the purpose of the analysis, the type of sample and the compounds contained therein, the measurement environment such as the degree of disturbance and noise, or the measurement conditions. This enables region estimation with accuracy according to the conditions desired by the user.

(Item 7) The waveform analysis method according to any one of Items 1 to 6 may further comprise a resampling step of resampling the data constituting the target signal waveform at a sampling interval corresponding to the length of one processing target waveform in the horizontal axis direction and the predetermined data size, prior to the waveform decomposition by the waveform decomposition step.

(Item 19) The waveform analysis apparatus according to any one of Items 13 to 18 may further comprise a resampling unit configured to resample the data constituting the target signal waveform at a sampling interval corresponding to the length of one processing target waveform in the horizontal axis direction and the predetermined data size, prior to the waveform decomposition by the waveform decomposition unit.

In the waveform analysis method described in Item 7 and the waveform analysis apparatus described in Item 19, the sampling interval of the target signal waveform is constant regardless of the sampling interval of the original signal waveform. Also, the positions of the sampling points in the overlap portion of a plurality of processing target waveforms become the same. This improves the accuracy of region estimation using the trained model. Furthermore, when integrating the individual region estimation information in the overlap portion, since there is no deviation of sampling points for each processing target waveform, the accuracy of the integrated region estimation information is improved, and the accuracy of peak region estimation using this is also improved.

(Item 8) In the waveform analysis method according to any one of Items 3 to 6, the integration step may use compound information regarding a target compound when calculating the statistical value or when selecting the type of the statistical value.

The “compound information” here can include, in addition to information on the compound itself such as a concentration value, for example, information on an isomer of the compound, information on a derivative generated by pretreatment, etc.

For example, when the concentration value given as compound information is low, it is assumed that the S/N ratio is low, and when the concentration value is high, it is assumed that the S/N ratio is high. Therefore, when the concentration value is low, by using the maximum value as the statistical value for the non-peak region, it becomes difficult to misrecognize noise as a peak, and when the concentration value is high, by using the minimum value as the statistical value for the non-peak region, a waveform that may be a peak can be estimated as a peak as much as possible. Also, when compound information indicating the existence of an isomer is given, an overlapping peak with a slight retention time shift is likely to appear, so by using the maximum value as the statistical value for the overlapping peak region, it is possible to make it easier for an estimation of an overlapping peak to be made. In this way, according to the waveform analysis method described in Item 8, the detection rate of peaks and overlapping peaks under low-concentration conditions can be improved.

(Item 9) In the waveform analysis method according to any one of Items 1 to 8, the waveform length of the processing target waveform may be determined based on at least one of an input size of a trained model, an analysis time, a peak width, and a sampling rate.

According to the waveform analysis method described in Item 9, since the width of the window, that is, the length of the processing target waveform, is appropriately determined, the accuracy of region estimation using the trained model is improved, and peak detection can be performed more accurately.

(Item 10) In the waveform analysis method according to any one of Items 1 to 9, the plurality of different types of regions may include, in addition to a non-peak region, a single peak region with one peak, an overlapping peak region where a plurality of peaks overlap, a peak start region including a peak start position, and a peak end region including a peak end position.

In the waveform analysis method described in Item 10, by changing the type of statistical value used for each of the non-peak region, the peak start region, the peak end region, the single peak region, and the overlapping peak region, peaks can be detected more accurately.

(Item 11) In the waveform analysis method according to any one of Items 3 to 6, the integration step may calculate one or more of an S/N ratio, a degree of separation, a symmetry factor, a proportion of peak clipping, a peak height, or a peak width in the peak region, or a baseline slope in the non-peak region, and use the calculation result in combination when obtaining the individual region estimation information.

According to the waveform analysis method described in Item 11, by using information such as the S/N ratio in the peak region, the peak height, or the degree of separation, the symmetry factor, the proportion of peak clipping, and the peak width, which affect the peak shape, for region estimation, the peak region can be estimated more accurately. Also, by using baseline information such as the baseline slope for region estimation, the non-peak region can be estimated more accurately.

(Item 12) The waveform analysis method according to any one of Items 3 to 6 may further comprise a display step of displaying the statistical value on a screen.

According to the waveform analysis method described in Item 12, the user can quantitatively grasp the statistical value that forms the basis for the determination of each region. This allows the user to make adjustments to improve the accuracy of peak detection, such as changing the type of statistical value to be used, as needed.

(Item 20) One aspect of the analysis apparatus according to the present invention may be any one of a chromatograph apparatus, a mass spectrometer, and a spectrophotometer, comprising the waveform analysis apparatus according to any one of Items 13 to 19 as a data analysis unit.

According to the analysis apparatus described in Item 20, high qualitative performance and quantitative performance can be achieved by using highly accurate peak information.

### REFERENCE SIGNS LIST

1 . . . GC measurement unit
2 . . . Data analysis unit
20 . . . Data collection unit
21 . . . Peak detection processing unit
210 . . . Resampling unit
211 . . . Waveform division processing unit
212 . . . Determination unit
213 . . . Trained model storage unit
214 . . . Overlap portion estimation value adjustment unit
215 . . . Waveform integration processing unit
216 . . . Region determination unit
22 . . . Qualitative/quantitative analysis unit
23 . . . Display processing unit
24 . . . Input unit
25 . . . Display unit
3 . . . Model creation unit
30 . . . Training data storage unit
31 . . . Training execution unit
32 . . . Model storage unit

1. A waveform analysis method for analyzing a signal waveform that is a chromatogram or a spectrum, the method comprising:
a model creation step of creating a trained model for identifying a peak portion included in an input waveform by machine learning using a plurality of reference waveforms in which the position of the peak portion is known;
a waveform decomposition step of decomposing a target signal waveform to be analyzed into a plurality of processing target waveforms, each having a predetermined data size, so as to cover the entire waveform in a horizontal axis direction;
a region estimation step of dividing each of the plurality of processing target waveforms into a plurality of partial waveforms in the horizontal axis direction, and for each processing target waveform, using the trained model to estimate whether each of the plurality of partial waveforms included in the processing target waveform corresponds to each of a plurality of different types of regions including a peak region and a non-peak region, and obtaining individual region estimation information reflecting a probability of the correspondence;
an integration step of integrating the individual region estimation information obtained for each partial waveform of each of the plurality of processing target waveforms in the region estimation step, to obtain region estimation information corresponding to the whole or a part of the target signal waveform; and
a region determination step of using the region estimation information to determine which of the plurality of regions each part in the whole or a part of the target signal waveform is.

2. The waveform analysis method according to claim 1, wherein
in the waveform decomposition step, a plurality of processing target waveforms in which at least a part of a range overlaps with other processing target regions are acquired by applying a sliding window method to the target signal waveform in the horizontal axis direction, and
in the integration step, in a range where the plurality of processing target waveforms overlap, integrated region estimation information is obtained based on the individual region estimation information obtained for each of the overlapping ranges of the plurality of processing target waveforms.

3. The waveform analysis method according to claim 2, wherein
the individual region estimation information is an estimated value reflecting a probability of corresponding to each region, and
in the integration step, in a range where the plurality of processing target waveforms overlap, a statistical value is obtained by a statistical process from estimated values obtained for each corresponding partial waveform for each of the overlapping ranges of the plurality of processing target waveforms.

4. The waveform analysis method according to claim 3, wherein the statistical value includes one of a maximum value, a minimum value, a median value, an average value, or a mode value.

5. The waveform analysis method according to claim 4, wherein in the integration step, in a range where the plurality of processing target waveforms overlap, a minimum value is used as a statistical value for a non-peak region, and a maximum value is used as a statistical value for regions other than the non-peak region.

6. The waveform analysis method according to claim 4, further comprising a statistical value determination step of determining a type of the statistical value to be used in the range where the plurality of processing target waveforms overlap in the integration step, based on a user's instruction.

7. The waveform analysis method according to claim 1, further comprising a resampling step of resampling data constituting the target signal waveform at a sampling interval corresponding to a length of one processing target waveform in the horizontal axis direction and the predetermined data size, prior to the waveform decomposition by the waveform decomposition step.

8. The waveform analysis method according to claim 3, wherein in the integration step, compound information regarding a target compound is used when calculating the statistical value or when selecting a type of the statistical value.

9. The waveform analysis method according to claim 1, wherein a waveform length of the processing target waveform is determined based on at least one of an input size of the trained model, an analysis time, a peak width, and a sampling rate.

10. The waveform analysis method according to claim 1, wherein the plurality of different types of regions include, in addition to a non-peak region, a single peak region where one peak is present, an overlapping peak region where a plurality of peaks are overlapping, a peak start region including a peak start position, and a peak end region including a peak end position.

11. The waveform analysis method according to claim 3, wherein in the integration step, one or more of an S/N ratio, a degree of separation, a symmetry factor, a proportion of peak clipping, a peak height, or a peak width in the peak region, or a baseline slope in the non-peak region, is calculated, and a result of the calculation is used in combination when obtaining the individual region estimation information.

12. The waveform analysis method according to claim 3, further comprising a display step of displaying the statistical value on a screen.

13. A waveform analysis apparatus for analyzing a signal waveform that is a chromatogram or a spectrum, the apparatus comprising:
a waveform decomposition unit configured to decompose a target signal waveform to be analyzed into a plurality of processing target waveforms, each having a predetermined data size, so as to cover the entire waveform in a horizontal axis direction;
a region estimation unit configured to divide each of the plurality of processing target waveforms into a plurality of partial waveforms in the horizontal axis direction, and for each processing target waveform, using a trained model created by machine learning using a plurality of reference waveforms in which a position of a peak portion is known for identifying a peak portion included in an input waveform, to estimate whether each of the plurality of partial waveforms included in the processing target waveform corresponds to each of a plurality of different types of regions including a peak region and a non-peak region, and to obtain individual region estimation information reflecting a probability of the correspondence;
an integration processing unit configured to integrate the individual region estimation information obtained for each partial waveform of each of the plurality of processing target waveforms in the region estimation unit, to obtain region estimation information corresponding to the whole or a part of the target signal waveform; and
a region determination unit configured to use the region estimation information to determine which of the plurality of regions each part in the whole or a part of the target signal waveform is.

14. The waveform analysis apparatus according to claim 13, wherein
the waveform decomposition unit is configured to acquire a plurality of processing target waveforms in which at least a part of a range overlaps with other processing target regions by applying a sliding window method to the target signal waveform in the horizontal axis direction, and
the integration processing unit is configured to, in a range where the plurality of processing target waveforms overlap, obtain integrated region estimation information based on the individual region estimation information obtained for each of the overlapping ranges of the plurality of processing target waveforms.

15. The waveform analysis apparatus according to claim 14, wherein
the individual region estimation information is an estimated value reflecting a probability of corresponding to each region, and
the integration processing unit is configured to, in a range where the plurality of processing target waveforms overlap, obtain a statistical value by a statistical process from estimated values obtained for each corresponding partial waveform for each of the overlapping ranges of the plurality of processing target waveforms.

16. The waveform analysis apparatus according to claim 15, wherein the statistical value includes one of a maximum value, a minimum value, a median value, an average value, or a mode value.

17. The waveform analysis apparatus according to claim 16, wherein the integration processing unit is configured to, in a range where the plurality of processing target waveforms overlap, use a minimum value as a statistical value for a non-peak region, and use a maximum value as a statistical value for regions other than the non-peak region.

18. The waveform analysis apparatus according to claim 16, further comprising a statistical value setting unit configured to determine a type of the statistical value to be used in the range where the plurality of processing target waveforms overlap in the integration processing unit, based on a user's instruction.

19. The waveform analysis apparatus according to claim 13, further comprising a resampling unit configured to resample data constituting the target signal waveform at a sampling interval corresponding to a length of one processing target waveform in the horizontal axis direction and the predetermined data size, prior to the waveform decomposition by the waveform decomposition unit.

20. An analysis apparatus, being any one of a chromatograph apparatus, a mass spectrometer, and a spectrophotometer, comprising the waveform analysis apparatus according to claim 13 as a data analysis unit.
